(19) United States
(12) Patent Application Publication
(10) Pub. No.: US 2008/0232689 A1
(43) Pub. Date: Sep. 25, 2008

(54) Coding systems for Chinese characters and uses thereof

(76) Inventor: Cheng-Fu Lee, San Jose, CA (US)

Correspondence Address: Cheng-Fu Lee, 1552 Chambers Drive, San Jose, CA, 95118, US

(21) Appl. No.: 11/055,999

(22) Filed: Feb. 11, 2005

(30) Foreign Application Priority Data
Feb. 11, 2004 (TW) 093103125

(51) Int. Cl. G06K 9/18

(52) U.S. Cl. 382/185

(57) ABSTRACT

User friendly coding systems are provided for Chinese characters, either complicated or simplified. Each Chinese character is assigned a code based on the shape of the character. In particular, the characters sharing the same beginning strokes are grouped together. The coding systems are useful for searching or sorting Chinese characters, as well as for typing Chinese characters on a computer or word processor.

### RELATED APPLICATION

This application claims priority under 35 U.S.C §119 to Taiwan Patent Application No. 093103125, filed Feb. 11, 2004, the disclosure of which is incorporated by reference in its entirety.

### FIELD OF INVENTION

This invention relates to coding systems for Chinese characters and uses thereof. In particular, the codes can be used to sort or search Chinese characters. The codes may also be used to key in Chinese characters into a computer or word processor.

### BACKGROUND

The current Chinese dictionaries sort Chinese characters by a combination of traditional radicals and number of strokes. Traditional radicals are parts of characters that are shared by many characters. Therefore, the characters that share a common radical are classified in the same group. The problems of this system are that it is difficult to recognize traditional radicals since they can appear in any place within a character, and characters of the same number of strokes are not in any order.

The current internal code lists are in two parts, arranged by “48 strokes-214 traditional radicals.” It is very inconvenient to sort using this system.

There are no correlations between codes and characters and one can not recognize the codes by characters. Moreover, the number of codes is fixed and can not be updated.

In this world of fast development, everything needs to be precise and prompt; with frequent interactions among people and higher dependence of supply and demands. Chinese has to be connected with other ones in the world to meet the requirements of international exchanges of cultures.

### SUMMARY OF THE INVENTION

This invention provides user-friendly coding systems for either complicated or simplified characters. In the systems, Chinese characters are still classified by radicals, but the radicals in the systems described herein are always located in the beginning part of a character (“the character head”). The radicals herein are classified into 6 groups based on the shape of the first stroke of each radical (which is also the first stroke of the character having the radical). Although there are eight basic stroke shapes in Chinese characters (see Table I), the last two are not used as the first stroke in a character.

The 6 groups of radicals are further arranged in a table for ease of use. Table II is an example of such a table of radicals. Thus, based on similarities among radicals, the radicals in each group are arranged in rows and columns. Each radical in the table can thus be identified by its location in the table, i.e., by identifying which row and which column the radical is located in. In Table II, each row is designated by a key (the “key name”), and each column is also designated by a key (the “radical order”).

In the coding systems, each Chinese character has a code, comprising at least three keys. The first two keys are derived from the radical of the character. Based on Table II, the first two keys would be the keys for the row and column for the radical, i.e., the key name and radical order. The remaining key(s) can be determined in several different ways. In the Character-order code, there are 4 keys. In addition to the first two keys as described above, the third key of the code is determined according to the shape of the first stroke of the character body (the part of the character after the radical is removed) of the character, and the fourth key of the code is determined according to the number of strokes in the character body of the character.

A “Simple-easy code” system has also been developed, wherein each code consists of 5 keys. The third to fifth keys of the code are determined according to the shapes of the first three strokes of the character body of the character. If the character body has less than three strokes, the third, fourth or fifth keys may be zero, indicating no stroke.

The code may be a Frequently-used code consisting of 3 to 5 keys, wherein the third, fourth or fifth key of the code is determined according to the shape of the character body of the character. Thus, if the character body contains any radical as listed in Table II, and keys of the radical are used as the third to fifth keys, as the case may be.

Accordingly, one aspect of the present invention provides a coding system for Chinese characters wherein each Chinese character is assigned a code, characterized by:
a. Said coding system devides Chinese characters into 6 groups according to the shape of the first stroke of each Chinese character;
b. there is a table of radicals for the 6 groups, the table having rows and columns, each row being represented by a key, each column being represented by a key, and each radical in the table being represented by a combination of two keys, which are the key for the row and the key for the column where the radical is located;
c. the code for a character has at least 3 keys, the first two keys being the combination of two keys representing the radical of the character.

Preferably, the shape of the first stroke of each Chinese character is described in Table I, and the table of radicals comprises Table II. The Chinese character may be a simplified character or a complicated character. The code may be a Character-order code consisting of 4 keys, wherein the third key of the code is determined according to the shape of the first stroke in the character body of the character, and the fourth key of the code is determined according to the number of strokes in the character body of the character. The Character-order code is preferably listed in Attachment 2.

The code may be an Simple-easy code consisting of 5 keys, wherein the third to fifth keys of the code are determined according to the shapes of the first three strokes of the character body of the character, and wherein the third, fourth or fifth keys may be zero if the character body has less than three strokes. The Simple-easy code is preferably listed in Attachment 2.

The code may be a Frequently-used code consisting of 3 to 5 keys, wherein the third, fourth or fifth key of the code is determined according to the shape of the character body of the character by identifying in the character body any radical as listed in Table II. The Frequently-used code is preferably listed in Attachment 2.

Another aspect of the present invention provides a method of entering Chinese characters in a computer or word processor, comprising using any of the codes described herein.

Yet another aspect of the present invention provides a method of sorting or searching for Chinese characters, comprising using any of the codes described herein.

### DETAILED DESCRIPTION OF THE INVENTION

The purpose of this invention is to build a clear, convenient, easy to add and delete Chinese system of sorting and searching, which can be updated all the time.
I. Sorting of Chinese:
   1. Coding of Stroke shapes: The Chinese characters are composed of strokes. The coding of stroke shapes shall make the radical and character codes in objective order.
   2. Characters arranged by radicals: The radicals are based on the common character heads in order to determine the radicals and codes by looking at the characters.
   3. Sorting by character codes: To code by number of strokes of each character so that users can recognize the code order by the spacing strokes and the character orders in the same codes by stroke codes.
II. Chinese Character Lists: It will make the character order precise without losing the orderliness when adding/deleting characters to sort by Character-order Codes: radical codes.
III. Applications of Chinese Character Lists: The language is intertwined with the lives and cultures. With the three codes: precise Character order Codes, convenient Simple-easy Codes and quick Frequently-used Codes, the system helps people control the Chinese characters disregard of their ages and nationalities.
IV. Sorting Program: It displays the Chinese with two codes: frequent/sub frequent codes and single codes in orders for the public to use and international cultural exchange.

### DEFINITIONS

1. troke shapes: The [symbol] eight stroke shapes are the basic Forms composing standard Chinese characters.
2. Stroke Codes: The eight stroke shapes are coded by 12345678 as the objective basis of sorting and searching.
3. Radicals: They are originally for classification of names and objects; And are classified by features; and located on the head of the characters. Therefore, user shall determine the radicals easily by the characters. It should be emphasized that the radicals used in this invention are not necessarily the same as the traditional radicals. A “radical” of a character, as used in this invention, is always located in the character head. In other words, the “radical” must contain the first stroke of the character. The traditional radical may be in any place within a character. Therefore, the radical of a character, as used in this invention, may be different from the traditional radical for the same character. Unless specified as “traditional radical”, the term “radical” means the first stroke or first several strokes of a character that is shared among a group of characters. Exemplary radicals are listed in Table II.
4. Classifications: Based on the first stroke shapes, the radicals are divided into 6 categories. Only one category is needed for searching; and priorities of the categories can be determined by the code of strokes.
5. Radical shapes: These are in the principle of singleness to have the unison of the radical and character shapes. For example, the radicals[ [symbol] ] (of water and clothes) differ and will belong to different radicals. They will not be combined in the same category because they have the same meaning. Few radicals and characters such as [ [symbol] and [symbol] and [symbol] ] are in the same category to be easily recognized.
6. Radical codes: These are the codes for radicals by two keys—“Name of key and Order of radicals)” to locate the exact position of rows and columns. Example: [ [symbol] ] is at “e row and 1 column.” The radical code is, therefore, “el”.
7. Radicals order: This is the sorting of the radicals at the same keys. The 1(first column) radical of the six categories is sorted by “strokes number-strokes codes”; the 2-f radicals, in principle, sorted by “strokes codes-strokes number”. However, the radicals with the same meanings but in different shapes will be listed after the radicals of the same meanings. Example: [ [symbol] ] (of heart and clothes) disregard of the order of stroke codes. Even if addition/deletion of radicals, it will maintain the overall orderliness.
8. Character shapes: They are the complete structure of Chinese characters and are coded by standard regular styles (the current Song Ming Fonts are not standard fonts.) with the purpose to maintain the unison of fonts and codes so that users shall recognize the codes by the characters and recognize the character orders by stroke codes.
9. Character heads: The areas including the first stroke: the first stroke, beginning area, the several beginning areas or the complete characters. such as [symbol] are character heads(radicals). The more of the radical numbers, we get more capacity. The number of radical strokes is higher, and the character codes become simpler.
10. Character bodies: Parts other than character heads. Example, the character head of [ [symbol] ] is [ [symbol] ] with the body as [ [symbol] ].
11. Character codes: The codes of character bodies, including the two keys [stroke codes-number of strokes] with the purpose to determine the orders by density.
12. Categorization: To categorize the characters with same number of strokes with the initial stroke code of character bodies in order to reduce the checking number of characters to ⅙-8. The character codes are in numbers to be precise while maintaining the orderliness when adding/deleting characters.
13. Number of strokes: Referring to the number of strokes of character bodies. Only 15 strokes are taken to prevent from complication. They are represented by 1-9, a-e for 1-14 strokes and, f to represent 15 strokes and above.
14. Character order: To rearrange the characters with the same strokes to differentiate the priority and locate each character.
15. Character-order Codes: These are the codes especially for Chinese character sorting, including 292 radical codes and one character code which contains 90 codes to be shared with all radicals. There are only four keys to build an everlasting order for all Chinese characters.
16. Chinese Character List: To order by Character-order Codes so that all the Chinese characters can be chained together and positioned. Any other codes using Chinese Character List with same codes, we can have those characters correctly ordered.
17. Simple-easy Codes: These are the most convenient codes for inputting and searching. The radical codes(the 1-2 keys) are the same with Character-order Codes. The character codes(the 3-5 keys) are taken from the first three strokes codes in five keys for entering. So that users do not need to bother counting the number of strokes and do not need to memorize character codes. In the meantime, the same character codes mean that this part shapes of the characters are the same or similar making it easy to search.
18. Frequently-used Codes: This is the best way to enter the characters. The radical codes(the 1-2 keys) are the same with Character-order Codes. The character codes(the 3-5 keys) are used to spell the character bodies. The 32 keys shall represent all the shapes of radicals and characters. Least key are used and it is not necessary to select characters, making it fast to enter characters. Nevertheless, for characters with similar shapes such as [symbol] [symbol] they require careful recognition for correct entering. Entering will be correct and quick once you are familiar with these codes. It will be an easy job to write with keyboards and you will not know how convenient it is until you try.
19. Sorting program: It is aimed to build common orders by using a single character order to meet the modern requirements; with the help of computers and to stay connected with foreign languages; and promote the cultural exchanges for the universal values.
V. Chinese character sorting: The Character-order Codes are based on stroke shape codes and rearrange the order of Chinese characters with radical and character codes to establish the eternal order of Chinese characters and make character searching and data processing convenient.
   1. Knowing the stroke codes: The Chinese characters are composed of strokes. The coding of stroke shapes, will make it ordered.
      A. Stroke shapes: After analyzing the stroke shapes, we can have 8 basic stroke shapes with 10 variations.
      B. Writing techniques: They refer to the directions of strokes, regardless of the length and thickness of strokes.
      C. Number of strokes: For complicated strokes such as 7L Land their variations, from the dotting to raising the pen is one stroke. Examples: [symbol] —one stroke and [symbol] —2 strokes.
      D. Stroke codes: Represented by 1-8 as 8 stroke shapes (See Table I: Stroke-shape List). There are three purposes:
         a. The radicals are divided into 6 categories by shapes of initial stroke. One category is needed when checking in radicals.
            (See Table II: Radicals List)
         b. Two keys are required for character codes; the first ones are in 6-8 divisions by stroke shape codes, When using characters of the same number of strokes, it is reduced to ⅙-8,
         c. The characters in the same codes are arranged by stroke codes in order.

TABLE I
Stroke Shape List

| Stroke | | | | Basic | | |
|---|---|---|---|---|---|---|
| Codes | Name | Phonetics | Pinyin | strokes | Variation | Writing Techniques |
| 1 | Dot | [symbol] | Dian3 | [symbol] | | Motionless After |
| | | | | | | dotting |
| 2 | Hor, line | [symbol] | Heng2 | [symbol] | | From left to right |
| 3 | Ver. Line | [symbol] | Zhi2 | [symbol] | [symbol] | From top to bottom |
| 4 | L, faliing | [symbol] | Pie3 | [symbol] | | From top right toLeft-falling |
| | stroke | | | | | stroke |
| 5 | Folding | [symbol] | Zhe2 | [symbol] | [symbol] | Folding after horizontal line |
| 6 | Curve | [symbol] | Yi n3 | [symbol] | [symbol] | Turn right After straight |
| | | | | | | stroke |
| 7 | Raising | [symbol] | Tiao3 | [symbol] | | From bottom left up to top |
| | | | | | | right |
| 8 | R. falling | [symbol] | Na4 | [symbol] | [symbol] | From top Left downTo |
| | stroke | | | | | rightbottom |

2. Knowing radicals: Chinese characters can be divided into heads and bodies.
   The former are used as radicals with the characters having same heads and users shall recognize the radicals by looking at the characters and find out the characters with same radicals easily. The current internal codes include all 13067 Chinese characters (after deduction of [symbol] an [symbol] ), with the 115 created characters: include new stroke shapes and radicals for a total 13182 characters. This new system re-groups these characters into 6 categories with 32 basic radicals, 260 extended radicals: total 292 radicals. (See Table II and Attachment 1: Radicals List)
A. Structure of Radicals List:
   a. The columns 1 and 2 include [category/key names], detailing the six categories, 32 key names and the total number.
   b. Columns 3-17 include 292 radicals, 15 radical orders. Beside the 19 subsidiary radicals next to radicals (the second and third aracters), there are 7 bold subsidiary characters at the end in radicals cells.
   c. Columns 18 and 19 record the total numbers of the 32 basic radicals, the subsidiary radicals and the subsidiary characters.
   d. In the 32 [key names], keys 1-6 are first radical in six categories of radicals while the 26 alphabet keys are allocated into the first 5 categories of:
      1, a, b, c and d: total of 5 keys
      2, e, f, g, h, I, j, k, l, m, n, o: total of 12 keys
      3, p, q, r, s: total of 5 keys
      4, t, u, v, w, x, y: total of 7 keys
      5, z: total of 2 keys
      6: total of 1 key
   e. There are 15 columns under radicals and radical orders represented radical orders by 1-9 and a-f.
   f. There are 273 radical numbers) in the left column under [total] with 19 subsidiary radicals and 7 subsidiary characters in the right column.
B. Positioning of radicals: Characters head means the position: [top, top and bottom, left, left and right, middle, outside] part of a character, or a other whole characters used as the radicals, users do not have to spend much time looking up. Examples: radical [symbol] on the top; radical of [symbol] on both top and bottom; [symbol] on the left; [symbol] of on the left and right; [symbol] of [symbol] and [symbol] in the middle, [symbol] of [symbol] surrounding.
C. Categories of initial stroke: Six categories of radicals are made according to the initial strokes and only the one stroke of the radicals is to be determined.
D. Two shapes of radicals: To recognize the radical shapes with character shapes and only character heads are required.
   a. Basic radical shapes: Least strokes are in the total of 32 first radicals. The radicals order is 1: with 1-6 keys of single strokes for the initial radicals of the six categories; a-z keys include 26 radicals of 2-4 strokes, which are listed behind the 1-5 initial radicals.
      Example: [ [symbol] ] categories two strokes [ [symbol] ] 5 radicals, are ordered by stroke [symbol] ; 3 strokes [ [symbol] ] 3 radicals, with the same stroke numbers and codes, only have changes in lengths in the second and third strokes; 4 strokes— [symbol] 3 radicals to be ordered by the third stroke [symbol] e-o keys also correspond to the radicals order. Once users are familiar with these shapes, they do not even need to think before entering characters.
   b. Extended radical shapes: These are the addition, deletion or changes of the radical shapes or stroke codes of the initial radicals shapes: such as: [ [symbol] ] are addition of strokes; [ [symbol] ] are deletion of strokes; and [ [symbol] ], [ [symbol] ], [ [symbol] ] etc. are changes of initial radicals. All these have become separate radicals.
   c. Subsidiary radicals and characters: The same radicals cells with two or three listed simultaneously are because of the shapes are similar to the original radicals with only slight differences. Such characters include [ [symbol] 11, [symbol] 111, [symbol] 112]. The last two radicals are the subsidiary radicals to differentiate the shapes of the radicals with a total of 19 radicals. There are 4 bold radical original— characters [ [symbol] ] listed behind the radicals, which will help users recognize the characters. The three bold characters [ [symbol] ] only show the shapes similar and without any other radical belonging to. Therefore, they are listed as subsidiary characters.
E. Radical Codes: [Key names-Radical orders] two keys are used as radical codes to indicate the radicals where row of key names and key orders meet. Users can enter the radicals by radical codes. Examples:
   a. Radical [ [symbol] ] is under [symbol] category f row, 1 column, hence the radical code is [f1]; [ [symbol] ] is at [f, 6], hence the code is [f6]. Users shall be able to enter [ [symbol] ] or [ [symbol] ] by keying in [f1] or [f6].
   b. Numbers [1, 2, . . . ] are added behind the radical orders as the entering codes for subsidiary radicals and characters. Examples: enter: [r31] for [ [symbol] ]; [r32] for [ [symbol] ]. The subsidiary radicals are behind the original ones while the subsidiary characters are behind the radicals.
F. Radicals Order: The purpose is to determine the priority of radicals By radical shapes; once users understand the order, they can fully comprehend all the radicals.
   a. The radicals order 1 of 32 initial radicals are arranged by [stroke numbers-stroke codes]; order 2-f with same keys are arranged by troke codes-stroke numbers]. That is, when the initial strokes other than the initial radicals are the same, the order will be arranged by number of strokes. However, radicals with same keys and same meanings are to be listed behind the original radicals, as [symbol] disregard of the order of stroke codes. Those with same meanings but different keys are to be ordered by the radicals shapes. Example: radical code of [ [symbol] ] is [14], and code [37] is for [symbol]
   b. Line a, columns 2-e with 13 radicals include initial radical [ [symbol] ], among which, the initial stroke beyond the radicals of lines 2-6 include [ [symbol] ]. Lines 2-5 include [ [symbol] ] with increasing number of strokes, examples: [symbol] and [symbol] the initial strokes of line 7-e are 2, 3, 3, 4, 4, 5, 6, and 6, those with same codes of initial strokes are arranged by numbers of strokes, such as [symbol] ; those with same numbers of strokes are arranged by stroke codes such as [symbol] The orders of radicals are not in a mess as a result.
   c. Line t, columns 2-7 include [ [symbol] and [symbol] ]. The six radicals)
      include [ [symbol] ]. Among which, [ [symbol] ] maintain the original shapes of [symbol] ; [ [symbol] ], however, changes the shapes of [ [symbol] ] because of the addition of strokes with slightly different structure. Four radicals) [ [symbol] ] in columns 8-b are based on radical [ [symbol] ], (stroke code 422). [ [symbol] ] and [ [symbol] ] with same initial strokes are arranged by numbers of strokes respectively.
G. Recognition of radicals: Radicals are for classifications. Those with similar shapes but different pronunciations and meanings require attention, such as [symbol] (15, [symbol] ), 16 [symbol] ); [symbol] (s1), [symbol] (s2); [symbol] (w2 [symbol] ), [symbol] (w3); (z4), [symbol] (z41), and [symbol] (z5).
H. Prompt of radicals: In addition to looking up into the table of radicals on the paper, there are two methods available to familiarize with order of radicals:
   a. Check the 32 [name of keys] and [shapes of initial radicals] in the small keyboards on the Windows display.
   b. Press any key among 1-6 or a-z and space for [radicals] and [order of radicals].

TABLE II
Radicals List

| | Key | Radicals and Orders | | | | | | | | | | | | | | Total |
|---|---|---|---|---|---|---|---|---|---|---|---|---|---|---|---|---|
| Categories | Names | 1 | 2 | 3 | 4 | 5 | 6 | 7 | 8 | 9 | a | b | c | D | e | 292 |
| [symbol] | 1 | [symbol] | [symbol] | [symbol] | [symbol] | [symbol] | [symbol] | [symbol] | [symbol] | | | | | | | 10 |
| [symbol] | A | [symbol] | [symbol] | [symbol] | [symbol] | [symbol] | [symbol] | [symbol] | [symbol] | [symbol] | [symbol] | [symbol] | [symbol] | [symbol] | [symbol] | 15 |
| [symbol] | B | [symbol] | [symbol] | [symbol] | [symbol] | [symbol] | [symbol] | [symbol] | [symbol] | [symbol] | [symbol] | [symbol] | [symbol] | | | 14 |
| [symbol] | C | [symbol] | [symbol] | [symbol] | [symbol] | [symbol] | | | | | | | | | | 5 |
| [symbol] | D | [symbol] | [symbol] | [symbol] | [symbol] | | | | | | | | | | | 4 |
| [symbol] | 2 | [symbol] | [symbol] | [symbol] | [symbol] | [symbol] | [symbol] | [symbol] | [symbol] | [symbol] | [symbol] | [symbol] | [symbol] | [symbol] | | 13 |
| [symbol] | E | [symbol] | [symbol] | [symbol] | [symbol] | [symbol] | [symbol] | [symbol] | | | | | | | | 7 |
| [symbol] | F | [symbol] | [symbol] | [symbol] | [symbol] | [symbol] | [symbol] | [symbol] | [symbol] | [symbol] | [symbol] | [symbol] | | | | 11 |
| [symbol] | G | [symbol] | [symbol] | [symbol] | [symbol] | [symbol] | [symbol] | [symbol] | | | | | | | | 7 |
| [symbol] | H | [symbol] | [symbol] | [symbol] | [symbol] | [symbol] | [symbol] | [symbol] | [symbol] | | | | | | | 8 |
| [symbol] | I | [symbol] | [symbol] | [symbol] | [symbol] | [symbol] | [symbol] | [symbol] | [symbol] | [symbol] | | | | | | 9 |
| [symbol] | J | [symbol] | [symbol] | [symbol] | [symbol] | [symbol] | [symbol] | [symbol] | [symbol] | [symbol] | | | | | | 9 |
| [symbol] | K | [symbol] | [symbol] | [symbol] | [symbol] | [symbol] | [symbol] | [symbol] | | | | | | | | 7 |
| [symbol] | L | [symbol] | [symbol] | [symbol] | [symbol] | [symbol] | [symbol] | [symbol] | | | | | | | | 9 |
| [symbol] | M | [symbol] | [symbol] | [symbol] | [symbol] | | | | | | | | | | | 4 |
| [symbol] | N | [symbol] | [symbol] | [symbol] | [symbol] | [symbol] | [symbol] | | | | | | | | | 6 |
| [symbol] | O | [symbol] | [symbol] | [symbol] | [symbol] | | | | | | | | | | | 4 |
| [symbol] | 3 | [symbol] | [symbol] | [symbol] | [symbol] | [symbol] | [symbol] | [symbol] | [symbol] | | | | | | | 8 |
| [symbol] | P | [symbol] | [symbol] | [symbol] | [symbol] | [symbol] | [symbol] | [symbol] | | | | | | | | 7 |
| [symbol] | Q | [symbol] | [symbol] | [symbol] | [symbol] | | | | | | | | | | | 4 |
| [symbol] | R | [symbol] | [symbol] | [symbol] | [symbol] | [symbol] | [symbol] | | | | | | | | | 8 |
| [symbol] | S | [symbol] | [symbol] | [symbol] | [symbol] | [symbol] | [symbol] | [symbol] | [symbol] | [symbol] | [symbol] | | | | | 10 |
| [symbol] | 4 | [symbol] | [symbol] | [symbol] | [symbol] | [symbol] | [symbol] | [symbol] | [symbol] | [symbol] | [symbol] | [symbol] | [symbol] | | | 12 |
| [symbol] | T | [symbol] | [symbol] | [symbol] | [symbol] | [symbol] | [symbol] | [symbol] | [symbol] | [symbol] | [symbol] | [symbol] | | | | 11 |
| [symbol] | U | [symbol] | [symbol] | [symbol] | [symbol] | [symbol] | | | | | | | | | | 5 |
| [symbol] | V | [symbol] | [symbol] | [symbol] | [symbol] | [symbol] | [symbol] | [symbol] | [symbol] | | | | | | | 8 |
| [symbol] | W | [symbol] | [symbol] | [symbol] | [symbol] | [symbol] | [symbol] | [symbol] | [symbol] | [symbol] | [symbol] | [symbol] | [symbol] | [symbol] | [symbol] | 14 |
| [symbol] | X | [symbol] | [symbol] | [symbol] | [symbol] | [symbol] | [symbol] | [symbol] | [symbol] | | | | | | | 8 |
| [symbol] | Y | [symbol] | [symbol] | [symbol] | [symbol] | [symbol] | [symbol] | [symbol] | [symbol] | [symbol] | | | | | | 9 |
| [symbol] | 5 | [symbol] | [symbol] | [symbol] | [symbol] | [symbol] | [symbol] | [symbol] | [symbol] | [symbol] | [symbol] | [symbol] | [symbol] | | | 12 |
| [symbol] | Z | [symbol] | [symbol] | [symbol] | [symbol] | [symbol] | [symbol] | [symbol] | [symbol] | [symbol] | [symbol] | [symbol] | [symbol] | | | 12 |
| [symbol] | 6 | [symbol] | [symbol] | [symbol] | [symbol] | [symbol] | [symbol] | [symbol] | [symbol] | [symbol] | [symbol] | [symbol] | [symbol] | | | 12 |
| Total | 32 | 32 | 32 | 32 | 32 | 28 | 26 | 24 | 19 | 14 | 11 | 10 | 8 | 3 | 2 | 273 |

### Explanations:

(1) The 32 key names represent 32 basic radicals, 241 extended radicals, 19 subsidiary radicals and 7 subsidiary characters (in bold letters).
(2) Six single strokes are the 6 initial radicals; a-z keys represent the basic radicals of 2-4 strokes; 2-f represent the 14 radicals with the same keys,
(3) The radicals indicate the character heads, meaning the initial strokes or the shapes of radicals containing initial strokes. Users shall recognize the radicals by looking at the characters.
(4) Basic radicals shall be recognized by the small keyboards on the screen while the extended radicals by pressing key names and space. Memorizing is not required.
3. Knowing the character codes: To code by character bodies will enable user to recognize the codes by looking at the characters. There is only one form of character code—the two keys behind the codes of radicals and it applies to all the radicals. (See Attachment 2 Chinese Characters List: the third and four keys in the Character-order Codes)
   A. Classification: 6-8 groups are made by codes of initial strokes to reduce the number of characters with same code into ⅙-8.
   B. Character codes: 90 codes are arranged with character body [initial stroke-stroke numbers]. Strokes numbers 1-14 are represented by 1-9 and a-e, and f represents numbers 15 and larger than 15. Example: the character head of [ [symbol] ] is [symbol] , and the radical code is 11; the character code of the body of [ [symbol] ] is [24] with the initial stroke code as 2 and 4 the number of strokes.
   C. Character orders: Characters with the same codes are arranged by stroke codes of character bodies to make searching easy. Example: there are two characters[ [symbol] and [symbol] ] under character code 1215. The stroke codes of [ [symbol] ] is 142 while that of [ [symbol] ] is 161. Therefore, [ [symbol] ] is ahead of [ [symbol] ]. Also, character code 1157 has two characters—[ [symbol] and [symbol] ]. The last two strokes of [ [symbol] ] are 53 while those of [ [symbol] ] are 33. The order by strokes should be [ [symbol] ]. Nevertheless, [ [symbol] ] is more frequently used than [ [symbol] ]. It is arranged ahead as a result.
   D. Number of characters in divided radicals: The system has 273 radicals with 13,182 characters at 48.3 characters in one radical. Averaged by 90 codes per radical, one code has 0.54 character. The actual average numbers are: 241 radicals with less than 90 characters or 88% of total radicals (i.e. average one character per code); 25 radicals with 91-360 characters or 9% of total radicals (i.e. average 2-4 characters per code); 7 radicals with 361-800 characters or 3% of total radicals (i.e. average 5-9 characters per code). Under this system, searching is easy as there are few repeated characters in the great numbers of Character-order Code.
   E. Ratio of character/code: The list contains 13,182 Chinese characters sharing 5,608 codes with an average 2.4 characters per code. The actual ratios: 3,328 codes with one character per code or 59% of total codes; 2,089 codes with 2-9 characters with 7,215 characters. The two make a total of 97% of codes and 80% of characters. The repeated characters of codes are few making the searching easy. Based on the 20 codes used out of the 90 codes in each radicals, there is still a large quantity left to process high volume data.
VI. Chinese Characters List: Using 4 keys of Character-order Codes, this whole table is ordered like a chain with each character positioned. Once users are familiar with the format of coding, they can control all characters by the shapes of characters. As a result, Chinese Character Table is the foundation of coding, basis of sorting and beginning of all the applications (See Attachment 2: Chinese Characters List).
   1. Features: The making of this table is to be once and for all with three features different from the current methods:
      A. Precision: The radicals are on the character heads and are arranged in stroke; numbers of strokes are divided by stroke codes; and the characters with same codes are ordered by stroke codes. Such arrangement makes the order of characters objective. From the statistics of searching by codes, 97% codes and 80% characters are with less than 9 characters (turning page is not necessary to select characters); 17% are with less than 18 characters (turning one page for selecting characters). There will be no mistakes in searching.
      B. Popularity: Coding of stroke shapes grants order attributes and makes classification of radicals, and number of strokes, and order of characters possible. Coding of radicals, all are based on shapes of radicals. The radicals shape dividing the basic and extended parts makes the 32 basic radicals and 260 extended radicals related and the 32 keys with rich content. Regular users shall know its convenience to recognize the radicals with character heads; character codes with character; however, for advanced users, codes will express the structure of the whole characters and make them joyous.
      C. Constancy: Orders are available for codes of radicals and characters and will not be changed when characters are added or deleted. This feature allows users to update the content all the time without losing orderliness and makes the list constantly applicable (See Character-order Codes of Chinese Character List). Moreover, the Sorting program of this system is the extension of Character list. Once users are familiar with the same order of this system, it will help make this system more popular.
2. Method of Searching: Regular dictionaries are full of sorting methods by characters, vocabulary shapes, pronunciations, and meanings have lots of contents, and users have to spend lots of time and energy to locate the words. In computers, you can use “find” to search what you are looking for and any entering methods will do. This system, thanks to its simplicity, is like a string of beads with simple structure of character list. Users do not need to press keys to search. Only the recognition of codes will be fine.
   Method of character-order (6f-8f): To confirm the codes of radicals by recognized the initial stroke and shape of character head; and determine codes of characters by initial stroke and stroke numbers of character body, and you will see the characters in the same category. For example, if you need to search the character [ [symbol] ] (See Character-order Codes of Chinese Character Table), the searching orders are:
      a. From the six categories of radicals, locate the radical [ [symbol] ] with the key name [1].
      b. From the 15 radical orders of the List of radicals, locate the radical [ [symbol] ] with the radical order [1], and you have now the code of the radical) [11].
      c. You can learn that the initial stroke code is [2] from the initial stroke [ [symbol] ] of the body [ [symbol] ].
      d. The number of strokes of [ [symbol] ] is [4], and you get the character code [24].
      e. Press [1124]+space, and the character [ [symbol] ] is entered automatically (with only this character appeared and selection of characters is not necessary).
      Once users are familiar with this search, they can determine the codes of radicals and characters and they can press codes of 1124 directly and get the character [ [symbol] ]. When using computers, you can scroll up or down or turning the pages when using the real objects. What matters is that you can “locate the characters by code orders”.
VII. Application of Chinese Characters List: The language and live, culture will coexist everywhere. The features of Chinese Character List improve the convenience in the daily lives and works to be proved from the two following methods.
   1. Simple-easy Codes: Five keys of [key names-radical orders/stroke code-stroke code-stroke code] are used. Two keys of radical codes are the same as those of Character-order Code; three keys of character codes are the first 3 stroke codes of character bodies. 0 will be used when less than 3 keys.
      A. Features of Simple-easy Code: (See Attachment 2 Chinese Characters List: Simple-easy Codes) A popular input method.
         a. Character codes: No need to count the number of strokes. Instead, only the first 3 stroke codes are needed; the order to select the characters is the same as that of Character-order Codes. The density of characters are easily seen and convent for selection.
         b. Characters of the same codes: The characters of similar shapes are combined, such as 18222 containing the characters of different stroke numbers [ [symbol] ]. This is the most convenient searching.
         c. Order of characters with the same codes: To be arranged by [frequently used characters-number of strokes], [less frequently used characters-number of strokes]. For example, code 11522 has six characters—[ [symbol] ] and [ [symbol] ]. These 6 are arranged by the numbers of stroke separately.
         d. Precision of the characters with the same codes: Except for [ [symbol] and [symbol] ], there is no third character containing [ [symbol] ].
         e. Convenient for the elders as well as the young: Local elders do not feel like using computers while foreign Chinese do not use computers in Chinese operating system. Actually, it is not that difficult to use computer Chinese operating systems/software. Once you are familiar, you will enjoy using it.
         f. Borderlessness: There is an increasing number of foreigners using Chinese operating system. The Simple-easy Codes will help improve the efficiency and their working ability.
      B. Operation of Simple-easy Codes: An example of a four-character phrase [symbol] [symbol]
         a. The head [ [symbol] ] of [ [symbol] ] is on the left; the radical code is [L5]; the first three strokes codes of body [ [symbol] ] are [352]. Press L5352+space and you have 9 characters of [symbol] [symbol] and [symbol] characters. Press 2 to enter [ [symbol] ].
         b. The head [ [symbol] ] of [ [symbol] ] is on the left with the radical code [U1]; the first 3 stroke codes of body [ [symbol] ] are [281]. Press U1281+space and you have: [symbol] and [symbol] Press 1 to enter [ [symbol] ].
         c. The head of [ [symbol] ] is [ [symbol] ] with the radical code [R3], the stroke codes of body [1] are [300]. Press R3300+space for: [symbol] without selection.
         d. [ [symbol] ] is a radical with code [AB]; which do not require character codes. Press AB+space to have [ [symbol] ]. The radical is one character by direct entering.
         e. Explanations:
            The numbers of strokes of the first 8 characters in example a are increasing while that of the ninth character decreases, meaning that it is a less frequently used character.
            The first five characters in example b are frequently used while the last two are less frequently used.
         The characters in examples c and d are to be entered directly and the radicals require no character codes but with only the radicals codes.
   2. Frequently-used Codes: 3 to 5 keys are used: [key names-radical order/key name-key name-key name]. The two keys of radical codes are the same as those of Character-order and Simple-easy Codes. However, not all the 3 keys for Character codes are required. It is like a puzzle. Once you can spell a character with the first, or first and second keys, there is no need to use the second and third keys.
   A. Features of Frequently-used Codes: (See Attachment 2: Frequently-used Codes of Chinese Characters List)
      a. Simplification of Character codes: Each key shall represent a shape of a radical or a character; keys can be repeated to represent the same radical, character, or the other characters of the same radical, providing the freedom of using keys with. Examples: [symbol] m1u6, [symbol] 665, [symbol] w3, [symbol] r3rs, only require 13 keys of 4, 3, 2, 4 with the average of 3 keys per character.
      b. Accuracy of character codes: [symbol] (m1wr) and [symbol] (m2 wt) have different radical codes while [symbol] (S9QE) and [symbol] (S9W) have different character codes. Therefore, users have to be careful recognizing characters before entering. Once you are familiar with it, it will benefit all your life.
      c. Added order of the same codes: The character codes tend to be repeated in the radicals with many characters or keys with many radicals). Codes, as a result, the order of character codes have to be added for distinguishing.
         (a) 1 or 2 can be added after the codes on the characters using less than 3 keys. Example: [symbol] 6 as, and [symbol] 6as1. (See the 2 right lines in Character Table) [symbol] r1s, If [symbol] r1s1, and [symbol] r1s2. (See Frequently-Used Codes in Chinese Character List).
         (b) Provided 3 keys are already available, change the last one as 1; if the last key is already 1 or having other characters with the same codes, change it into 2, such as [symbol] r1x5, [symbol] r1x51, [symbol] r1x52, and [symbol] r1x53.
      d. Promptness of single codes: It is fast thanks to one code for one character without selection; being familiar with character codes will improve work efficiency.
   B. Operation of Frequently-used Codes: Still in the sample of [ [symbol] [symbol] ]
      [symbol] 12 keys are required to enter these four characters.
         a. The head [ [symbol] ] of [ [symbol] ] is on the left with radical code [L5]; the body [ [symbol] ] requires[S4]. Press L5S4+space to enter directly [ [symbol] ].
         b. The head [ [symbol] ] of [ [symbol] ] is on the left with radical code [U1]; the body [ [symbol] ] requires [H]. Press U1H+space for [ [symbol] ].
         c. The head of [ [symbol] ] is [ [symbol] ] with radical code [R3]; the body [1 ] is [3]. Press R33+space for [ [symbol] ].
         d. [ [symbol] ] is a radical, the code is AB; the radical requires no character codes. Press AB+space for[ [symbol] ].
   3. Example of Characters List: Representing 3 kinds of codes: the left are code of character order; the middle simple codes and the right frequently used codes.

TABLE III
Examples of Character List

| | | Simple- | | | |
|---|---|---|---|---|---|
| Character- | | easy | | Frequently- | |
| order Codes | Characters | Codes | Characters | used Codes | Characters |
| 11 | [symbol] | 11 | [symbol] | 11 | [symbol] |
| 1111 | [symbol] | 11100 | [symbol] | 111 | [symbol] |
| 1113 | [symbol] | 11123 | [symbol] | 11f | [symbol] |
| 1124 | [symbol] | 11223 | [symbol] | 11l | [symbol] |
| 1148 | [symbol] | 11455 | [symbol] | 114b | [symbol] |
| 1152 | [symbol] | 11580 | [symbol] | 112 | [symbol] |
| 1152 | [symbol] | 11580 | [symbol] | 113 | [symbol] |
| 1154 | [symbol] | 11554 | [symbol] | 115 | [symbol] |
| 1156 | [symbol] | 11522 | [symbol] | 11z | [symbol] |
| 1157* | [symbol] | 11522 | [symbol] | 11z5 | [symbol] |
| 1159* | [symbol] | 11522 | [symbol] | 11zw | [symbol] |
| 6b | [symbol] | 6b | [symbol] | 6b | [symbol] |
| 6b19 | [symbol] | 6b121 | [symbol] | 6ba | [symbol] |
| 6b46 | [symbol] | 6b435 | [symbol] | 6b4 | [symbol] |
| 6b49 | [symbol] | 6b482 | [symbol] | 6bx | [symbol] |
| 7 | [symbol] | 7 | [symbol] | 7 | [symbol] |
| 8 | [symbol] | 8 | [symbol] | 8 | [symbol] |
| 1128 | [symbol] | 11223 | [symbol] | 111w | [symbol] |
| 114a | [symbol] | 11455 | [symbol] | 114b5 | [symbol] |
| 1157* | [symbol] | 11522 | [symbol] | 11z3 | [symbol] |
| 1158 | [symbol] | 11554 | [symbol] | 115s | [symbol] |
| 1159# | [symbol] | 11522 | [symbol] | 11zwl | [symbol] |
| 115c | [symbol] | 11522 | [symbol] | 11zwj | [symbol] |
| 1215 | [symbol] | 12142 | [symbol] | 12bf | [symbol] |
| 695a | [symbol] | 69585 | [symbol] | 6955o | [symbol] |
| 695c | [symbol] | 69515 | [symbol] | 695q | [symbol] |
| 695c | [symbol] | 69522 | [symbol] | 69zs2 | [symbol] |
| 6965 | [symbol] | 69613 | [symbol] | 696r | [symbol] |
| 6a34 | [symbol] | 6a352 | [symbol] | 6as | [symbol] |
| 6a35 | [symbol] | 6a352 | [symbol] | 6asl | [symbol] |
| 6a36 | [symbol] | 6a354 | [symbol] | 6aq | [symbol] |
| 6a63 | [symbol] | 6a642 | [symbol] | 6a6/ | [symbol] |
| 6b36 | [symbol] | 6b352 | [symbol] | 6br | [symbol] |

A. Radicals codes: The first 2 keys, such as 11, are radical codes. Characters in the same radicals have the same radical codes.
B. Character codes: The next keys behind the radical codes: such as 11, 100, and 1 representing [character codes] are arranged in numbers.
C. Stroke codes: The two characters 695c [symbol] and [symbol] on the bottom left are with the same character codes of 5c, to be arranged by stroke codes of the character bodies. [symbol] 515 and [symbol] 522 are arranged by stroke codes (Please refer to the 3 lines of Simple-easy Codes).
D. Frequently and less frequently used: The top section of the Table represent frequently used characters while the bottom the less frequently. When entering, order of the characters with same codes is with the frequently used in front. Example: [symbol] and [symbol] of 1157* and [symbol] [symbol] of 1159#. However, in the event that no separation of frequently used and less frequently used in codes of character codes, the less frequently used characters with less strokes will be listed in front of frequently used characters with more, such as [symbol] 1158, and [symbol] 1159. This is correct.

VIII. New sorting codes for Characters: The Character Table in this system is arranged by Character-order Codes: to define the character shapes in 6 categories, 32 keys, 273 radical codes, with 8 divisions, 15 strokes, and 90 character codes. It is not just clear and neat with few characters in the same codes; what is better is that it rearranges the order with stroke codes. The characters with the same codes are positioned to make the order of characters. The new sorting program adopts the coding of 6 keys in detailed analysis, which is better than the 4-key character codes. It helps updating the data 9 and makes searching of Chinese characters easier and more prompt with broader application.

In the use on paper, the invention was indexed by table of radicals with the order of Chinese Characters List to process all the data such as dictionaries, data, files, names of people, places and objects for the maximum convenience. In the application in the computers, this will make the best performances in sorting, searching, inputting, coding, and data management.
IX. Attachments 1 and 2

Attachments 1 and 2 constitute part of this application. Attachment 1 is a list of radicals, which is similar to, but includes more details than, Table II. Attachment 2 is a list of Chinese characters showing the character-order code (column A), simple-easy code (column C), and frequently-used code (column E) for each character listed. Note that the characters are arranged according to their codes. Thus, column A lists the character-order codes in ascending order, and column B lists the characters corresponding to the codes in column A. Column C lists the simple-easy codes in ascending order, and column D lists the characters corresponding to the codes in column C. Similarly, column E lists the frequently-used codes in ascending order, and column F lists the characters corresponding to the codes in column E.

Also shown in Attachment 2 are the unicodes (column G) of characters (column H) and their corresponding frequent/sub codes (column 1) and single codes (column J). The frequent/sub and single codes are generated and used by a computer program prepared according to this invention.

I claim:

1. A coding system for Chinese characters wherein each Chinese character is assigned a code, characterized by:
a. Said coding system devides Chinese characters into 6 groups according to the shape of the first stroke of each Chinese character;
b. there is a table of radicals for the 6 groups, the table having rows and columns, each row being represented by a key, each column being represented by a key, and each radical in the table being represented by a combination of two keys, which are the key for the row and the key for the column where the radical is located;
c. the code for a character has at least 3 keys, the first two keys being the combination of two keys representing the radical of the character.

2. The coding system of claim 1 wherein the shape of the first stroke of each Chinese character is described in Table I, and the table of radicals comprises Table II.

3. The coding system of claim 1 wherein the Chinese character is a simplified character or a complicated character.

4. The coding system of claim 1 wherein the code is a Character-order code consisting of 4 keys, wherein the third key of the code is determined according to the shape of the first stroke of the character body of the character, and the fourth key of the code is determined according to the number of strokes in the character body of the character.

5. The coding system of claim 4 wherein the shape of the first stroke of each Chinese character is described in Table I, and the table of radicals comprises Table II.

6. The coding system of claim 5 wherein the Character-order code is listed in Attachment 1.

7. The coding system of claim 1 wherein the code is an Simple-easy code consisting of 5 keys, wherein the third to fifth keys of the code are determined according to the shapes of the first three strokes of the character body of the character, and wherein the third, fourth or fifth keys may be zero if the character body has less than three strokes.

8. The coding system of claim 7 wherein the shape of the first stroke of each Chinese character is described in Table I, and the table of radicals comprises Table II.

9. The coding system of claim 8 wherein the Simple-easy code is listed in Attachment 1.

10. The coding system of claim 1 wherein the code is a Frequently-used code consisting of 3 to 5 keys, wherein the third, fourth or fifth key of the code is determined according to the shape of the character body of the character by identifying in the character body any radical as listed in Table II.

11. The coding system of claim 10 wherein the shape of the first stroke of each Chinese character is described in Table I, and the table of radicals comprises Table II.

12. The coding system of claim 11 wherein the Frequently-used code is listed in Attachment 1.

13. A method of entering Chinese characters in a computer or word processor, comprising using the coding system of claim 1.

14. A method of entering Chinese characters in a computer or word processor, comprising using the coding system of claim 4.

15. A method of entering Chinese characters in a computer or word processor, comprising using the coding system of claim 7.

16. A method of soring or searching for Chinese characters, comprising using the coding system of claim 1.

17. A method of soring or searching for Chinese characters, comprising using the coding system of claim 4.

18. A method of soring or searching for Chinese characters, comprising using the coding system of claim 7.
